(19) United States
(12) Patent Application Publication
(10) Pub. No.: US 2016/0041991 A1
(43) Pub. Date: Feb. 11, 2016

(54) SYSTEMS, METHODS, AND COMPUTER-READABLE MEDIA FOR PROVIDING QUERY SUGGESTIONS BASED ON ENVIRONMENTAL CONTEXTS

(71) Applicant: Google Inc., Mountain View, CA (US)

(72) Inventors: Arnaud Sahuguet, New York, NY (US); Amir Menachem Mane, Lincroft, NJ (US); Travis Harrison Kroll Green, New York, NY (US); Jeremy Brand Sussman, Bedford Hills, NY (US); Aaron Baeton Brown, Croton on Hudson, NY (US)

(21) Appl. No.: 13/898,073

(22) Filed: May 20, 2013

(51) Int. Cl. G06F 17/30

(52) U.S. Cl. CPC G06F 17/3064

(57) ABSTRACT

Provided are systems, methods, and computer-readable media for providing query rewrites and autocompletions based on environmental contexts, such as the current time, the current weather, social networking recommendations, the presence at a location of a contact associated with the user, current events, or other contexts. A query is received from a user and environmental context data is retrieved. Next query suggestions, such as query rewrites and autocompletions, are retrieved from a query suggestion repository, and scores for each query suggestion are retrieved. Next, the scores are recalculated based on a relationship between environmental context data and the query suggestions. The query suggestions are ranked based on the recalculated scores and provided to the user for selection.

### BACKGROUND OF THE INVENTION

1. Field of the Invention

This invention relates generally to computer-implemented searches and, more particularly, to search query suggestions to rewrite or complete a search query.

2. Description of the Related Art

The Internet provides many different types of information and is useful for a variety of purposes. For example, users may use the Internet to retrieve information about businesses or other entities, view interactive maps, perform computer-implemented searches, etc. Users performing such searches may input a query having characters that form various terms of the query. However, users may mistype, misspell, or otherwise incorrectly input a search query. Additionally, a user may be uncertain of the best terms to use in a query, and may not input that query as quickly as the query can be processed.

### SUMMARY OF THE INVENTION

Various embodiments of methods, systems, and computer-readable media for providing query suggestions are provided herein. In some embodiments, a computer-implemented method is provided that includes obtaining, by one or more processors, a search query from a client computer and retrieving, by one or more processors, a plurality of query suggestions for the search query based on an analysis of a search log of previously executed search queries, the plurality of query suggestions respectively associated with a first plurality of scores based on first scoring criteria. The method further includes obtaining, by one or more processors, environmental context data associated with the search query and calculating, by one or more processers, a second plurality of scores for the plurality of query suggestions based on the first plurality of scores and the environmental context data. Additionally, the method includes ranking, by one or more processors, the plurality of query suggestions based on the second plurality of scores and providing, by one or more processors, the plurality of query suggestions to the client computer.

In another embodiment, a non-transitory tangible computer-readable storage medium having executable computer code stored thereon for providing query suggestions is provided. The computer code includes a set of instructions that causes one or more processors to perform the following: obtaining, by one or more processors, a search query from a client computer and retrieving, by one or more processors, a plurality of query suggestions for the search query based on an analysis of a search log of previously executed search queries, the plurality of query suggestions respectively associated with a first plurality of scores based on first scoring criteria. The computer code further includes a set of instructions that causes one or more processors to perform the following: obtaining, by one or more processors, environmental context data associated with the search query and calculating, by one or more processers, a second plurality of scores for the plurality of query suggestions based on the first plurality of scores and the environmental context data. Additionally, the computer code includes a set of instructions that causes one or more processors to perform the following: ranking, by one or more processors, the plurality of query suggestions based on the second plurality of scores and providing, by one or more processors, the plurality of query suggestions to the client computer.

Additionally, in another embodiment, a system for providing query suggestions is provided. The system includes one or more processors and a non-transitory tangible memory accessible by the one or more processors and having executable computer code stored thereon. The computer code includes a set of instructions that causes one or more processors to perform the following: obtaining, by one or more processors, a search query from a client computer and retrieving, by one or more processors, a plurality of query suggestions for the search query based on an analysis of a search log of previously executed search queries, the plurality of query suggestions respectively associated with a first plurality of scores based on first scoring criteria. The computer code further includes a set of instructions that causes one or more processors to perform the following: obtaining, by one or more processors, environmental context data associated with the search query and calculating, by one or more processers, a second plurality of scores for the plurality of query suggestions based on the first plurality of scores and the environmental context data. Additionally, the computer code includes a set of instructions that causes one or more processors to perform the following: ranking, by one or more processors, the plurality of query suggestions based on the second plurality of scores and providing, by one or more processors, the plurality of query suggestions to the client computer.

### BRIEF DESCRIPTION OF THE DRAWINGS

FIG. 1 is a schematic diagram of a system for receiving and processing a search query in accordance with an embodiments of the present technique;

FIG. 2 is a block diagram of a process for selecting and refining query suggestions based on environmental context in accordance with an embodiment of the present invention;

FIG. 3 is a block diagram of a process illustrating the retrieval of environmental context data in accordance with an embodiment of the present invention;

FIG. 4 is a block diagram of a process for providing query suggestions based on environmental context data in accordance with an embodiment of the present invention;

FIG. 5 is a block diagram of a process for evaluating the relationship between environmental contexts and related features of query suggestions in accordance with an embodiment of the present invention;

FIG. 6 is a block diagram of a process for providing query suggestions based on different search queries in accordance with an embodiment of the present invention; and

FIG. 7 is a block diagram of a computer in accordance with an embodiment of the present invention.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

As discussed in more detail below, provided in some embodiments are systems, methods, and computer-readable media for providing query rewrites and autocompletions based on environmental contexts, such as the current time, the current weather, social networking recommendations, the presence at a location of a contact associated with the user, current events, or other contexts. After a user submits a query, the query is received from the user and environmental context data is retrieved. Next query suggestions, such as query rewrites and autocompletions, are retrieved from a query suggestion repository, and scores for each query suggestion are retrieved. Next, the scores are recalculated based on the environmental context data. The recalculation may be based on an association between a query suggestion and the environmental context data, such that query suggestions having such an association have a higher score after the recalculation. The associations may include, for example, a predetermined relationship between an environmental context and a query suggestion, a comparison between the environmental context and the query suggestion (e.g., a string comparison between terms of the query suggestion and the environmental context data), or other associations.

The query suggestions may be ranked based on the recalculated scores for the query suggestions. Thus, the query rewrites or autocompletions having associations with environmental contexts may have relatively higher scores and may be ranked above the query rewrites or suggestions having relatively lower scores. The ranked query suggestions are then provided for selection by a user.

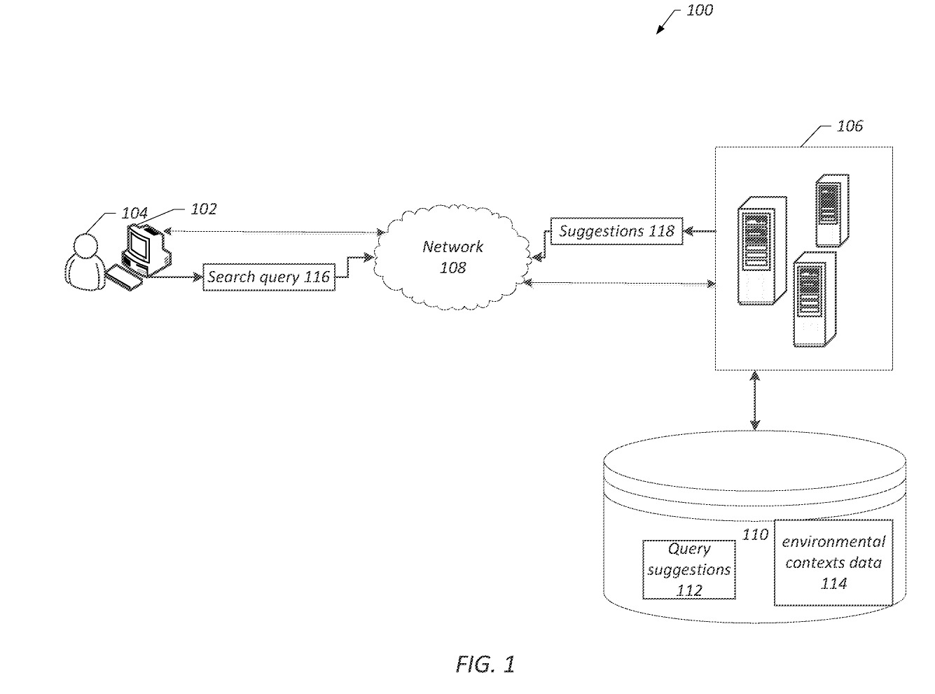

FIG. 1 depicts a system 100 for receiving and processing a search query in accordance with an embodiment of the present invention. As shown in FIG. 1, the system 100 may include a client computer 102 of a user 104. The user 104 may interact with the client computer to input search queries and perform computer-based searches. The client computer 102 may be in communication with servers 106 over a network 108, such that the client computer 102 may transmit data to and receive data from the servers 106. In some embodiments, the client computer 102 may include thick-clients, thin-clients, or both. The client computer 102 may be, for example, computers, such smartphones, tablet computers, laptop computers, desktop computers, etc. In some embodiments, the system 100 may include multiple clients 102. The servers 106 may include a single server (in a discrete hardware component or as a virtual server) or multiple servers. The servers 106 may include web servers, application servers, or other types of servers. The servers 106 may be, for example, computers arranged in any physical and virtual configuration, such as computers in one or more data processing centers, a distributed computing environment, or other configuration. Such configurations may use the network 108 for communication or may communicate over other networks. The network 108 may include any suitable network, such as the Internet, an intranet, a local area network (LAN), a wide area network (WAN), or any other suitable network.

The servers 106 may include a geographic information system (GIS), a search engine, web services, or any combination of these systems. The servers may access data repositories 110. As described further below, the data repositories 110 may include, for example, query suggestions 112 and environmental context data 114. In some embodiments, the servers 106 may include the data repositories 110, or the one or more of the data repositories may be stored on separate servers. In such embodiments, the client computer 102 may transmit a search query 116 to the servers 106. For example, the client computer 102 may present a search web page or an interactive map to a user, and the user may input a search query on the computer 102 to perform the search. After receiving the inputted query, the computer 102 may transmit the query 116 to the servers 106.

The servers 106 may receive and process the search query 116. As described further below, the servers 106 may provide query suggestions, such as query rewrites, query autocompletions, or both, based on the query 116. As described below, the query suggestions for the query may be determined from the query suggestions 112 and environmental context data 114. After determining query suggestions, the servers 106 transmit the query suggestions to the client computer 102 for selection by the user 104. Upon selection of a query suggestion, such as a query rewrite or autocomplete, the servers 106 receive the selection and provide search results based on the selected query suggestion. The servers 106 may send a response containing the data responsive to the query (i.e., search results) to the client computer 102.

The search query may include one, two, three, four, or any number of terms in various arrangements. Each term may have one or more characters. As explained below, a query suggestion may be an automatic completion (“autocompletion”) of the query or a rewrite of the query. For example, an autocompletion may add one or more characters or one or more terms to the query. A query rewrite may rewrite a query by replacing one or more terms of the query, e.g., with synonymous terms, or adding synonymous terms to the query.

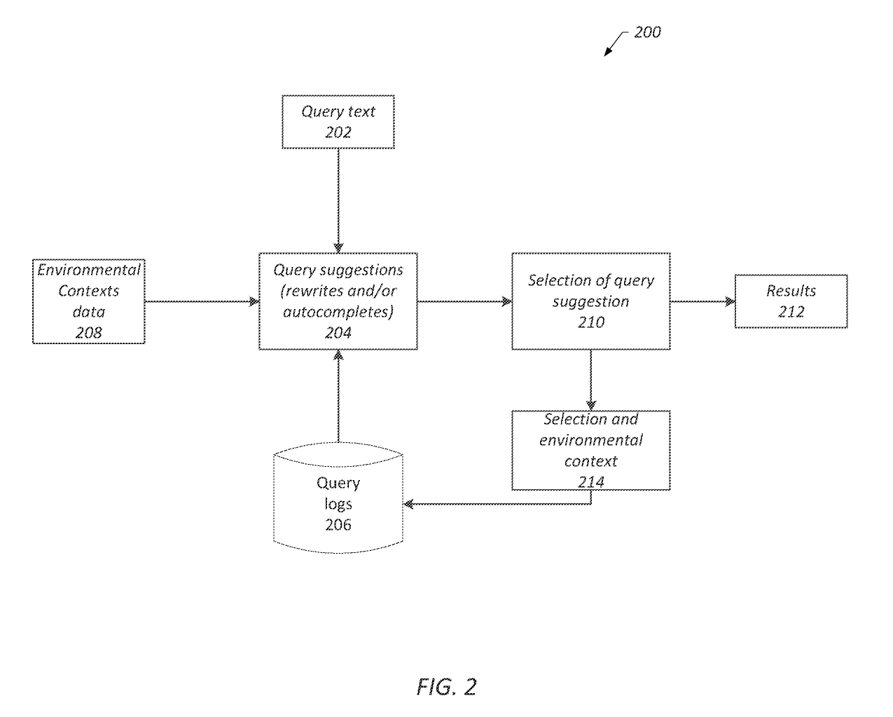

FIG. 2 depicts a process 200 for selecting and refining query suggestions based on environmental context in accordance with an embodiment of the present invention. Some or all steps of the process 200 may be implemented as executable computer code stored on a non-transitory tangible computer-readable storage medium and executed by one or more processors of a special-purpose machine, e.g., a general purpose computer programmed to execute the code. As described above, search query text 202 is received, such as from the client computer 102. The search query text 202 may include a portion of a query, such as one or more characters, one or more terms (e.g., phrases), etc. The search query text may include an entire query having one or more characters, one or more terms (e.g., a phrase), etc. Based on the search query text 202, query suggestions 204 (e.g., rewrites or autocompletions) may be determined and provided to the client computer 102.

As shown in FIG. 2, the determination of query suggestions 204 may be based on query logs 206 and environmental contexts data 208. The query logs 206 may include logs of previously executed queries previously submitted by users. A set of query suggestions 204 can be retrieved from the query logs 206 based on the received query text 202. For example, the set of query suggestions can consist of all previously submitted queries in query log 206 that match the received query text 202. Alternatively, the set of query suggestions can consist of previously submitted queries that match the received query and that were previously submitted more than a threshold number of times or at an average rate that is greater than a threshold rate. The query suggestions 204 may be scored based on information in the query logs (e.g., the number of times the query suggestion was previously received) and the score of each query suggestion can be further based on the environmental context data 208.

Next, after providing the query suggestions to a user, a selection 210 of a query suggestion may be received. For example, multiple autocompletions may be presented to a user, and the user may select one of the autocompletions to complete the query text and execute a search query. Similarly, multiple query rewrites may be presented to a user, and the user may select one of the query rewrites to replace some or all of the query text and execute a search query. In some embodiments, both query rewrites and autocompletions may be provided to a user, and the user may select from among both query rewrites and autocompletions. Search results 212 may then be provided to a user based on the search query from the selected search suggestion.

Additionally, a feedback mechanism may be provided to refine the query suggestions provided to a user for a search query. After a user selects a query suggestion, the selection and the associated environmental context 214 for the query may be stored in the query logs 206. Thus, as users make various selections of query suggestions that are based on specific environmental contexts, the query text, environmental context, and selected query suggestion may be stored in the logs. Accordingly, subsequent selection of query suggestions for the search query text, environmental context, or both may be based on previously selected search suggestions for the query text, environmental context, or both.

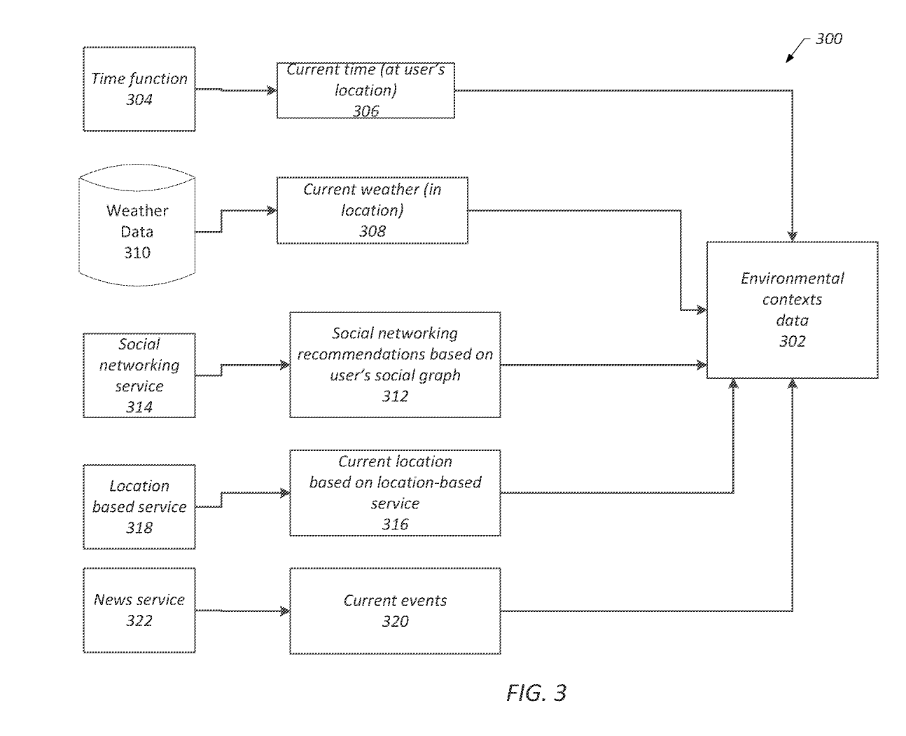

FIG. 3 depicts a schematic diagram 300 illustrating the retrieval of environmental context data 302 in accordance with an embodiment of the present invention. Some embodiments may include some or all of the environmental context data shown in FIG. 3 and described below, whereas other embodiments may include additional environmental context data not shown in FIG. 3. The illustrated functional blocks shown in FIG. 3 may be implemented on multiple systems and computers, and some of the functional blocks may be implemented on the same system and/or computer. The environmental contexts data 302 may be stored in any suitable data structure, such as one or more databases or other data repositories. The context data 302 may be provided and retrieved from user device, such as user's computer, or other computers or devices (e.g., via the “cloud”).

In some embodiments, the current time 306 (at a user's location) may be retrieved from a time function 304. For example, a user's location, such as determined from IP address geolocation or other location determinations, may be used by the time function 304 to determine current time 306. In some embodiments, the user's time zone (such as the time zone setting on the user's computer) may be obtained and the time function 304 may determine the current time 306 in the time zone. The current time 306 may be provided as environmental contexts data 302 for processing the query suggestions, as described further herein.

In some embodiments, the current weather 308 (e.g., the weather at a user's location) may be retrieved from weather data 310. The weather data 310 may be obtained from a weather data service. For example, the weather data 310 for a location may be obtained in real-time based on queries to a weather data service. The current weather 308 may include any number of indicia of the current weather. For example, the current weather 308 may include temperature, pressure, humidity, wind speed, wind direction, wind gust, precipitation, or any other indicia. The current weather 308, including some or all weather indicia, may be provided as environmental contexts data 302.

In some embodiments, the environmental context data 302 may include social networking recommendations 312. The social networking recommendations may be based on a user's social graph, as retrieved from a social networking service 314. The recommendations 312 may include recommendations for businesses and services such as restaurants, stores, bars, home repair, auto repair, etc. and public places such as parks, libraries. The social networking service 314 may include a social graph for a user, such as a group of contacts having a relationship with the user in the social networking service. The social graph of the social networking service 314 may be symmetric or asymmetric. The recommendations from the contacts in a user's social graph may be retrieved and provided as environmental context data 302. Accordingly, because the recommendations are determined from a user's social graph, they may be of particular interest to the user and may be used to generate or promote query suggestions.

Additionally, in some embodiments, the current location 316 of a user's social contacts, e.g., as determined from a location-based service 318, may be included in the environmental context data 302. In such embodiments, the location-based service 318 may provide indications of the presence (e.g., “check-in”) or absence (e.g., “check-out”) of the user's social contacts at a given entity. For example, upon arrival at an entity such as a restaurant, store, bar, etc., a user's social contact may check-in using the location-based service 318. Similarly, upon departure from the entity the user's social contact may check-out using the location-based service 318. The check-ins and check-outs indicate the social contact's presence or absence at the entity. When query suggestions are determined, the current locations of a user's social contacts may be provided as environmental context data 302 (e.g., to boost query suggestions related to those locations).

Moreover, in some embodiments, current events 320 may be provided as environmental context data. The current events 320 may be provided as various keywords or other descriptive terms, and may include, for example, sporting events, natural disasters, political events, technology events such as product releases or product announcements, etc. In some embodiments, the current events 320 may be specific to a user's location, such as a user's city, state or province, or country. In other embodiments, the current events 320 may be worldwide, and independent of a user's location. The current events 320 may be retrieved from a news service 322. The news service 322 may provide a ranked list of the top current events at a specific date and time, and/or for a particular place and time.

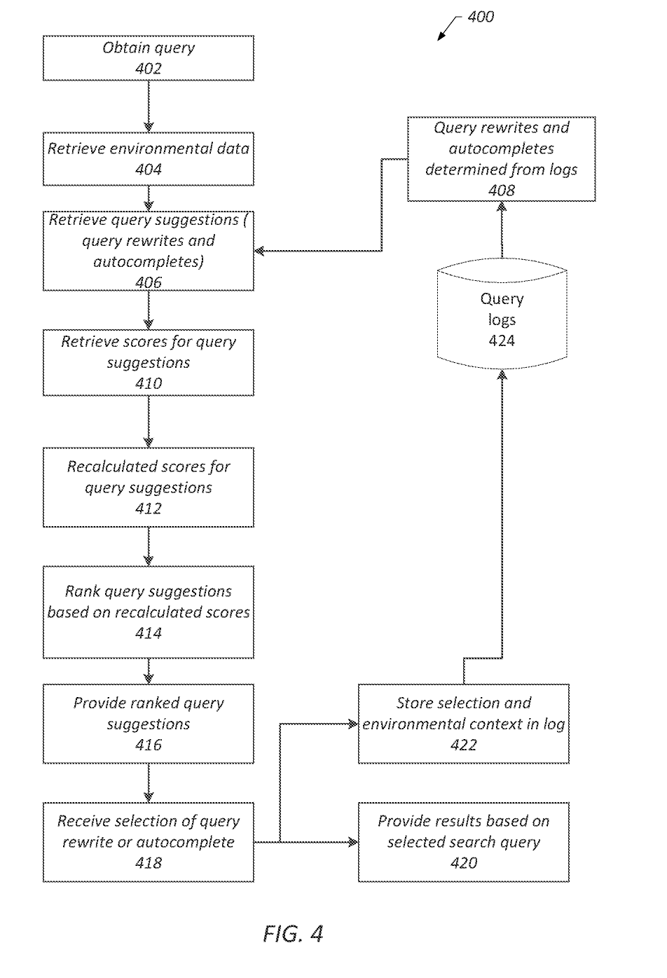

FIG. 4 depicts a process 400 for providing query suggestions based on environmental context data in accordance with an embodiment of the present invention. Some or all steps of the process 400 may be implemented as executable computer code stored on a non-transitory tangible computer-readable storage medium and executed by one or more processors of a special-purpose machine, e.g., a general purpose computer programmed to execute the code. Initially, as described above, a query may be obtained (block 402). As mentioned above, a user may input a search query into a client computer, and the query may be transmitted over a network to a server. Next, environmental context data may be retrieved (block 404). As described above, the environmental data may include various environmental contexts, such as current time, current weather, current events, social networking recommendations, etc. Some of the environmental contexts data may be user-specific, such as the location of the user (as determined from the client computer, from a user selection, or other determinations), or the current time or weather at the user's location. Other environmental contexts data may not be specific to a user, such as worldwide current events.

Next, query suggestions, such as query rewrites, autocompletions, or both, may be retrieved (block 406). As explained above, the query suggestions may be determined from query logs (block 408). Additionally, scores for the query rewrites, autocompletions, or both may be retrieved (block 410). The scores may be previously determined based on analysis of the query logs. In some embodiments, the scores may provide an indication of the likelihood that a query rewrite or autocomplete is the most popular rewrite or autocomplete for a given search query (e.g., based on the popularity of the query rewrite or autocomplete in the query logs, or the likelihood that a query suggestion is selected by a user when presented to the user).

Next, the scores for the retrieved query suggestions may be recalculated based on the environmental context data (block 412). For example, businesses such as restaurants may have weather-related features, such as terraces, patios, etc. A query suggestion that includes the business may be scored, in part, based on the current weather. For example, if the current temperature is above 70° F., the score of query suggestions that include restaurants having patios may be increased.

Next, the query suggestions may be ranked based on the recalculated scores (block 414). In embodiments for which the scores indicate of the likelihood that a query rewrite or autocomplete is the most popular rewrite or autocomplete for a search query, query rewrites or autocompletions having higher scores may be ranked above query rewrites or suggestions having lower scores. Next, the ranked query rewrites and autocompletions may be provided to a user (block 416). For example, the query suggestions may be presented to a user as a user-selectable list.

Next, a user's selection of a query rewrite or autocomplete may be received (block 418) and executed as a search query. Based on this search query, search results may be provided (block 420). For example, if a user inputs “how to make peach . . . ” a user may select the autocomplete “how to make peach cobbler” from a list of query suggestions, and results matching this search query may be provided. In another example, if a user inputs “how to make peech tea” a user may select the rewrite “how to make peach tea” from a list of query suggestions, and results matching this search query may be provided.

As mentioned above, selected query suggestions and associated environmental contexts may be logged to provide feedback for subsequent query suggestions. A selected query suggestion and its associated environmental context may be stored (block 422), such as in the query logs 424. For example, in the example discussed above, a user's selection of a query suggestion for a particular restaurant may be stored in the log, together with environmental context data such as the temperature and time the selection was made, as well as the restaurant's weather related features (e.g., its patio or terrace). The query logs 424 may be used in subsequent query suggestion determinations (block 408).

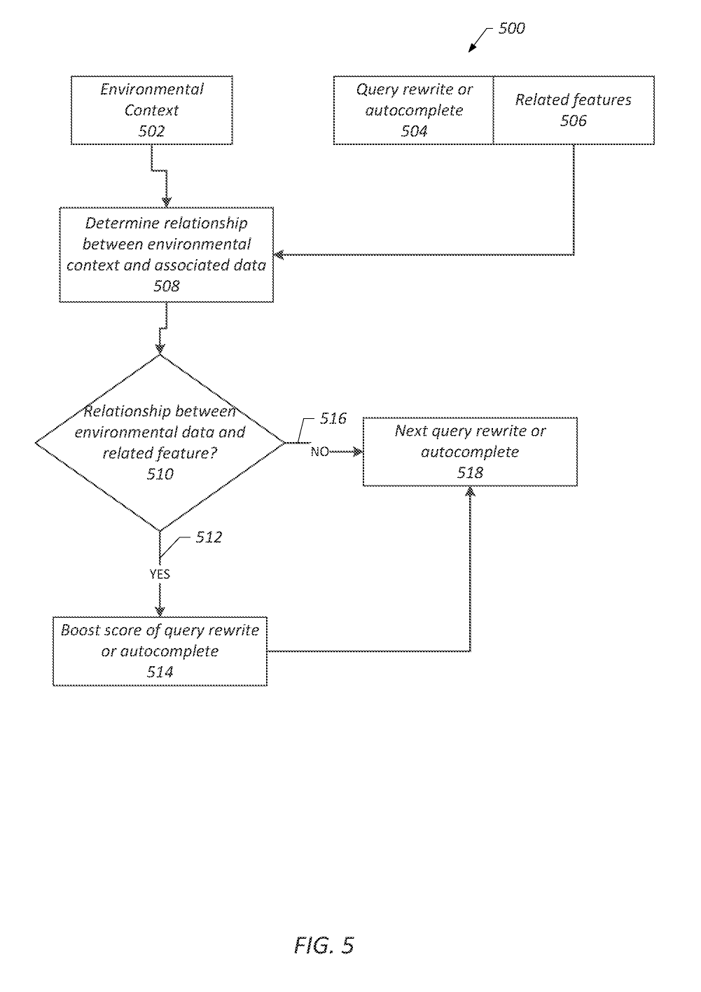

As described above, the recalculation of scores for various query suggestions may be based on environmental contexts and features of the query suggestion. For example, as explained above, query suggestions that include restaurants may be scored based on a relationship between the weather-related features of the restaurants and the current weather. FIG. 5 depicts a process 500 for scoring query suggestions based on environmental contexts and related features of query suggestions in accordance with an embodiment of the present invention. Some or all steps of the process 500 may be implemented as executable computer code stored on a non-transitory tangible computer-readable storage medium and executed by one or more processors of a special-purpose machine, e.g., a general purpose computer programmed to execute the code. Initially, as described above, environmental context data may be retrieved, such as from various sources illustrated above in FIG. 4. Additionally, a query suggestion 504 for a search query, and associated features 506 of the query suggestion 504, may be obtained, such as from query logs used to generate query suggestions.

Next a relationship between the environmental context and the associated features 506 may be determined (block 508). Such relationships may be stored in a data repository or other structure for retrieval. If a relationship exists between the environmental context and the associated feature of the query suggestion (line 512), then the score of the query suggestion may be increased (block 514). However, if no relationship exists between the environmental context and the associated feature of the query suggestion (line 516), then the process may iterate to the next query suggestion for the search query (block 518) without boosting the score for the current query suggestion. For example, if the environmental context is weather, and the query suggestion is not associated with any weather-related features, the score for the query suggestion will not be changed (e.g., increased or decreased) based on the current weather.

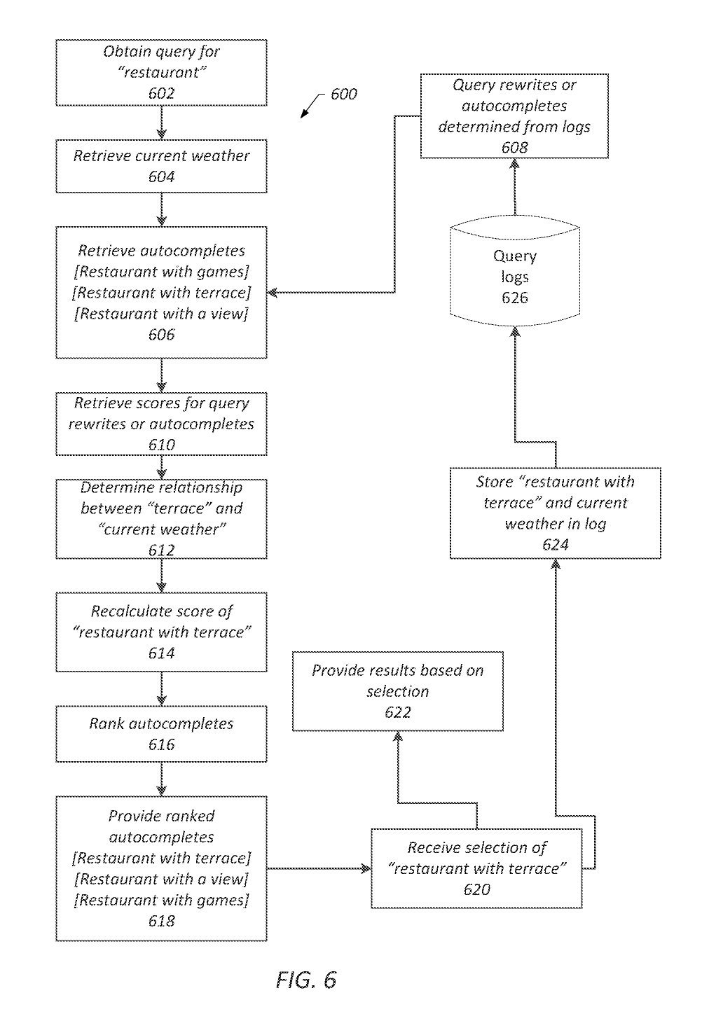

FIG. 6 depicts an example of providing query suggestions based on different search queries in accordance with embodiments of the present invention. Beginning with FIG. 6, a process 600 is depicted for proving query suggestions for search query text of “restaurant.” Initially, the text (“restaurant”) of the search query may be received (block 602). Next, an environmental context, such as the current weather, may be obtained (block 604). Based on the text of the search query, autocompletions may be obtained (block 606). The autocompletions may be determined from query logs depicting previous queries that included the text “restaurants” (block 608). For example, autocompletes may include “restaurant with games,” “restaurant with terrace,” and “restaurant with a view.”

Next, the scores for the autocompletions may be obtained (block 610). As noted above, these scores may be based on the popularity of the suggested search queries as determined from the query logs. The popularity can be measured based on the number of times the suggested search queries were received as search queries regardless of whether they were suggested, or the number of times the suggested search queries were selected when presented as suggested search queries. Next, the relationship (if any) between features of the suggested search queries and the environmental context data may be determined (block 612). Referring to the example described above, the query suggestion “restaurant with terrace” may be determined to have a relationship with the current weather.

Based on the relationships found between the environmental context and features of the query suggestions, the scores of the query suggestions may be recalculated. As shown in FIG. 6, the score of the “restaurant with terrace” query autocomplete may be recalculated (block 614) based on the current weather given the relationship between the weather-related feature of “terrace” and the weather. Next, the query autocompletions may be ranked based on the recalculated scores (block 616). The ranked query autocompletions may be provided for selection by a user (block 618). As shown in FIG. 6, the query autocompletions may be ranked in the following order: “Restaurant with terrace”; “Restaurant with a view”; and “Restaurant with games.” The query autocomplete “Restaurant with terrace” may be ranked first after recalculating the scores of the query autocompletions.

Next, a selection of a query autocomplete, e.g., “restaurant with terrace,” may be received (block 620). Query results may be provided (block 622) based on the selected search query of “restaurant with terrace.” Additionally, as described above, the selection and associated environmental context may be stored in the query logs 626 to provide feedback to the query autocomplete determinations. Thus, the selected query autocomplete of “restaurant with terrace” and the current weather may be stored (block 624), such as in the query logs (block 626). The selection may thus increase popularity of the query autocomplete “restaurant with terrace” for the environmental context of current weather.

In another example, a search query of “fan” may be entered by a user. In such an example, an environmental context of current events may be obtained from a news service and may include, for example, the “Super Bowl.” Query suggestions for the query “fan” may include a query autocomplete of “fan fiction,” and a query autocomplete of “fan of New York Giants”). Based on the environmental context, the query suggestion score for the query suggestions “fan of New York Giants” may be increased.

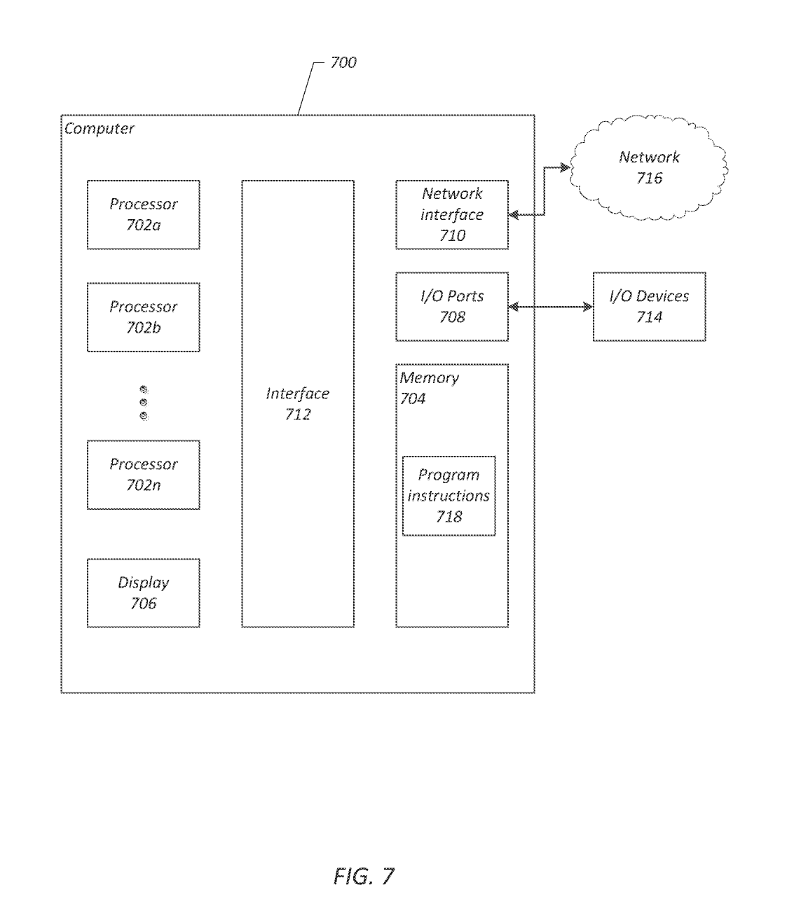

FIG. 7 depicts a computer 700 in accordance with an embodiment of the present invention. Various portions or sections of systems and methods described herein include or are executed on one or more computers similar to computer 700 and programmed as special-purpose machines executing some or all steps of processes described above as executable computer code. Further, processes, modules, and other components described herein may be executed by one or more processing systems similar to that of computer 700.

The computer 700 may include various components that contribute to the function of the device and enable the computer 700 to function in accordance with the techniques discussed herein. As will be appreciated, some components of computer 700 may be provided as internal or integral components of the computer 700 and some components may be provided as external or connectable components. Moreover, FIG. 7 depicts one example of a particular implementation and is intended to illustrate the types of components and functions that may be present in various embodiments of the computer 700.

Computer 700 may include a combination of devices or software that may perform or otherwise provide for the performance of the techniques described herein. For example, computer 700 may include or be a combination of a cloud-computing system, a data center, a server rack or other server enclosure, a server, a virtual server, a desktop computer, a laptop computer, a tablet computer, a mobile telephone, a personal digital assistant (PDA), a media player, a game console, a vehicle-mounted computer, or the like. The computer 700 may be a unified device providing any one of or a combination of the functionality of a media player, a cellular phone, a personal data organizer, a game console, and so forth. In some embodiments, the computer 700 may include a wearable computer, such as a wearable computer with a head-mounted display (HMD). Computer 700 may be connected to other devices that are not illustrated or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available. As shown in the embodiment illustrated in FIG. 7, the computer 700 may include one or more processors (e.g., processors 702a-702n), a memory 704, a display 706, I/O ports 708 a network interface 710, and an interface 712. Additionally, the computer 700 may include or be coupled to I/O devices 714.

In addition, the computer 700 may allow a user to connect to and communicate through a network 716 (e.g., the Internet, a local area network, a wide area network, etc.) and, in some embodiments, to acquire data from a satellite-based positioning system (e.g., GPS). For example, the computer 700 may allow a user to communicate using e-mail, text messaging, instant messaging, or using other forms of electronic communication, and may allow a user to obtain the location of the device from a satellite-based positioning system.

In some embodiments, the display 706 may include a liquid crystal display (LCD) an organic light emitting diode (OLED) display, or other display types. The display 706 may display a user interface (e.g., a graphical user interface) executed by the processor 702 of the computer 700. The display 706 may also display various indicators to provide feedback to a user, such as power status, call status, memory status, network status etc. These indicators may be incorporated in the user interface displayed on the display 706. In some embodiments, the display 706 may include or be provided in conjunction with touch sensitive elements through which a user may interact with the user interface. In such embodiments, a touch-sensitive display may be referred to as a “touch screen” and may also be known as or called a touch-sensitive display system.

The processor 702 may provide the processing capability to execute the operating system, programs, user interface, and other functions of the computer 700. The processor 702 may include one or more processors and may include “general-purpose” microprocessors, special purpose microprocessors, such as application-specific integrated circuits (ASICs), or any combination thereof. In some embodiments, the processor 702 may include one or more reduced instruction set (RISC) processors, such as those implementing the Advanced RISC Machine (ARM) instruction set. Additionally, the processor 702 may include single-core processors and multicore processors and may include graphics processors, video processors, and related chip sets. Accordingly, the computer 700 may be a uni-processor system having one processor (e.g., processor 702a), or a multi-processor system having two or more suitable processors (e.g., 702a-702n). Multiple processors may be employed to provide for parallel or sequential execution of the techniques described herein. Processes, such as logic flows, described herein may be performed by the processor 702 executing one or more computer programs to perform functions by operating on input data and generating corresponding output. The processor 702 may receive instructions and data from a memory (e.g., system memory 704).

The memory 704 (which may include one or more tangible non-transitory computer readable storage mediums) may include volatile memory and non-volatile memory accessible by the processor 702 and other components of the computer 700. The memory 704 may store a variety of information and may be used for a variety of purposes. For example, the memory 704 may store executable computer code, such as the firmware for the computer 700, an operating system for the computer 700, and any other programs or other executable code for providing functions of the computer 700. Such executable computer code may include program instructions 718 executable by a processor (e.g., one or more of processors 702a-702n) to implement one or more embodiments of the present invention. Program instructions 718 may include modules of computer program instructions for implementing one or more techniques described herein. Program instructions 718 may include a computer program (which in certain forms is known as a program, software, software application, script, or code). A computer program may be written in a programming language, including compiled or interpreted languages, or declarative or procedural languages. A computer program may include a unit suitable for use in a computing environment, including a stand-alone program, a module, a component, a subroutine, and the like. A computer program may or may not correspond to a file in a file system. A computer program may be stored in a section of a file that holds other computer programs or data (e.g., one or more scripts stored in a markup language document), in a single file dedicated to the program in question, or in multiple coordinated files (e.g., files that store one or more modules, sub programs, or sections of code). A computer program may be deployed to be executed on one or more processors located locally at one site or distributed across multiple remote sites and interconnected by a communication network. Additionally, the memory 704 may be used for buffering or caching during operation of the computer 700.

As mentioned above, the memory 704 may include volatile memory, such as random access memory (RAM). The memory 704 may also include non-volatile memory, such as ROM, flash memory, a hard drive, other suitable optical, magnetic, or solid-state storage mediums or any combination thereof. The memory 704 may store data files such as media (e.g., music and video files), software (e.g., for implementing functions on computer 700), user preference information, payment transaction information, wireless connection information, contact information (e.g., an address book), and any other suitable data.

The interface 712 may include multiple interfaces and may enable communication between various components of the computer 700, the processor 702, and the memory 704. In some embodiments, the interface 712, the processor 702, memory 704, and one or more other components of the computer 700 may be implemented on a single chip, such as a system-on-a-chip (SOC). In other embodiments, these components, their functionalities, or both may be implemented on separate chips. The interface 712 may coordinate I/O traffic between processors 702a-702n, the memory 704, the network interface 710, I/O devices 714, or any other devices or a combination thereof. The interface 712 may perform protocol, timing or other data transformations to convert data signals from one component (e.g., the memory 704) into a format suitable for use by another component (e.g., processors 702a-702n). The interface 712 may implement various types of interfaces, such as Peripheral Component Interconnect (PCI) interfaces, the Universal Serial Bus (USB) interfaces, Thunderbolt interfaces, Firewire (IEEE-1394) interfaces, and so on.

The computer 700 may also include an input and output port 708 to enable connection of additional devices, such as I/O devices 714. Embodiments of the present invention may include any number of input and output ports 708, including headphone and headset jacks, universal serial bus (USB) ports, Firewire (IEEE-1394) ports, Thunderbolt ports, and AC and DC power connectors. Further, the computer 700 may use the input and output ports to connect to and send or receive data with any other device, such as other portable computers, personal computers, printers, etc.

The computer 700 depicted in FIG. 7 also includes a network interface 710. The network interface 710 may include a wired network interface card (NIC), a wireless (e.g., radio frequency) network interface card, or combination thereof. The network interface 710 may include known circuitry for receiving and sending signals to and from communications networks, such as an antenna system, an RF transceiver, an amplifier, a tuner, an oscillator, a digital signal processor, a modem, a subscriber identity module (SIM) card, memory, and so forth. The network interface 710 may communicate with networks (e.g., network 716), such as the Internet, an intranet, a cellular telephone network, a wide area network (WAN), a local area network (LAN), a metropolitan area network (MAN), or other devices by wired or wireless communication. The communication may use any suitable communications standard, protocol and technology, including Ethernet, Global System for Mobile Communications (GSM), Enhanced Data GSM Environment (EDGE), a 3G network (e.g., based upon the IMT-2000 standard), high-speed downlink packet access (HSDPA), wideband code division multiple access (W-CDMA), code division multiple access (CDMA), time division multiple access (TDMA), a 4G network (e.g., IMT Advanced, Long-Term Evolution Advanced (LTE Advanced), etc.), Bluetooth, Wireless Fidelity (Wi-Fi) (e.g., IEEE 802.11 standards), voice over Internet Protocol (VoIP), Wi-MAX, an email protocol (e.g., Internet message access protocol (IMAP) or post office protocol (POP)), message-oriented protocols (e.g., extensible messaging and presence protocol (XMPP), Multimedia Messaging Service (MMS), Short Message Service (SMS), or any other suitable communications standards, protocols, and technologies.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM) and volatile or non-volatile media such as RAM (e.g. SDRAM, DDR, RDRAM, SRAM, etc.), ROM, etc.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

1. A computer-implemented method for providing query suggestions, the method comprising:
obtaining, by one or more processors, a search query from a client computer;
retrieving, by one or more processors, a plurality of query suggestions for the search query based on an analysis of a search log of previously executed search queries, the plurality of query suggestions respectively associated with a first plurality of scores based on first scoring criteria;
obtaining, by one or more processors, environmental context data for the search query, specific to at least one of a user or a time of the search query;
calculating, by one or more processers, a second plurality of scores for the plurality of query suggestions based on the first plurality of scores and the environmental context data, including determining a relationship between features of the plurality of query suggestions and the environmental context;
ranking, by one or more processors, the plurality of query suggestions based on the second plurality of scores; and
providing, by one or more processors, the plurality of query suggestions to the client computer.

2. The computer implemented method of claim 1, wherein providing the plurality of query suggestions to the client computer comprising transmitting the plurality of query suggestions to the client computer as a list of selectable query suggestions.

3. The computer-implemented method of claim 1, comprising receiving,
by one or more processors, a selection of one of the plurality of query suggestions as the search query and obtaining, by one or more processors, results from a search engine based on the selected query suggestion.

4. The computer-implemented method of claim 3, comprising storing the query suggestion selected as the search query and the environmental context in the search log.

5. The computer-implemented method of claim 1, wherein the environmental context includes a current time at a current location of the user.

6. The computer-implemented method of claim 1, wherein the plurality of query suggestions comprises a query autocomplete, a query rewrite, or a combination thereof.

7. (canceled)

8. A non-transitory tangible computer-readable storage medium having executable computer code stored thereon for providing query suggestions, the computer code comprising a set of instructions that causes one or more processors to perform the following:
obtaining, by one or more processors, a search query from a client computer;
retrieving, by one or more processors, a plurality of query suggestions for the search query based on an analysis of a search log of previously executed search queries, the plurality of query suggestions respectively associated with a first plurality of scores based on first scoring criteria;
obtaining, by one or more processors, environmental context data for the search query, specific to at least one of a user or a time of the search query;
calculating, by one or more processers, a second plurality of scores for the plurality of query suggestions based on the first plurality of scores and the environmental context data, including determining a relationship between features of the plurality of query suggestions and the environmental context;
ranking, by one or more processors, the plurality of query suggestions based on the second plurality of scores; and
providing, by one or more processors, the plurality of query suggestions to the client computer.

9. The non-transitory computer-readable medium of claim 8, wherein providing the plurality of query suggestions to the client computer comprises transmitting the plurality of query suggestions to the client computer as a list of selectable query suggestions.

10. The non-transitory computer-readable medium of claim 8, the computer code further comprising a set of instructions that causes one or more processors to perform the following: receiving, by one or more processors, a selection of one of the plurality of query suggestions as the search query and obtaining, by one or more processors, results from a search engine based on the selected query suggestion.

11. The non-transitory computer-readable medium of claim 8, wherein the environmental context comprises at least one of:
a current temperature,
a current time,
a current event,
recommendations from a social networking service,
a location-based presence from a location-based service, or
a combination thereof.

12. The non-transitory computer-readable medium of claim 8, wherein the plurality of query suggestions comprise a query autocomplete, a query rewrite, or a combination thereof.

13. (canceled)

14. A system for providing query suggestions, the system comprising
one or more processors;
a non-transitory tangible memory accessible by the one or more processors and having executable computer code stored thereon, the computer code comprising a set of instructions that causes one or more processors to perform the following:
obtaining, by one or more processors, a search query from a client computer;
retrieving, by one or more processors, a plurality of query suggestions for the search query based on an analysis of a search log of previously executed search queries, the plurality of query suggestions respectively associated with a first plurality of scores based on first scoring criteria;
obtaining, by one or more processors, environmental context data for the search query, specific to at least one of a user or a time of the search query;
calculating, by one or more processers, a second plurality of scores for the plurality of query suggestions based on the first plurality of scores and the environmental context data, including determining a relationship between features of the plurality of query suggestions and the environmental context;
ranking, by one or more processors, the plurality of query suggestions based on the second plurality of scores; and
providing, by one or more processors, the plurality of query suggestions to the client computer.

15. The system of claim 14, wherein providing the plurality of query suggestions comprises transmitting the plurality of query suggestions to the client computer as a list of selectable query suggestions.

16. The system of claim 14, the computer code further comprising a set of instructions that causes one or more processors to perform the following: receiving, by one or more processors, a selection of one of the plurality of query suggestions as the search query and obtaining, by one or more processors, results from a search engine based on the selected query suggestion.

17. The system of claim 14, wherein the environmental context comprises at least one of:
a current temperature,
a current time,
a current event,
recommendations from a social networking service,
a location-based presence from a location-based service, or
a combination thereof.

18. The system of claim 14, wherein the plurality of query suggestions comprises a query autocomplete, a query rewrite, or a combination thereof.

19. The computer-implemented method of claim 1, wherein the environmental context includes a current weather at a current location of the weather.

20. The computer-implemented method of claim 1, wherein the environmental context includes recommendations from a social networking service, based on a social graph of the user.

21. The computer-implemented method of claim 1, wherein the environmental context includes a current location of one or more social contacts of the user.

22. The computer-implemented method of claim 1, wherein the environmental context includes current events retrieved from a new service.
